(19) United States
(12) Patent Application Publication
(10) Pub. No.: US 2019/0266984 A1
(43) Pub. Date: Aug. 29, 2019

(54) MUSIC BOX APPARATUS

(71) Applicant: Yujin TSUKADA, Saitama-shi Saitama (JP)

(72) Inventor: Yujin TSUKADA, Saitama-shi Saitama (JP)

(21) Appl. No.: 16/065,632

(22) PCT Filed: Dec. 22, 2016
(86) PCT No.: PCT/JP2016/088338

§ 371 Date: Jun. 22, 2018

(30) Foreign Application Priority Data
Dec. 25, 2015 (JP) 2015-253905

(51) Int. Cl. G10F 1/06; G10F 5/04

(52) U.S. Cl. CPC G10F 1/06; G10F 5/04

(57) ABSTRACT

Provided is a novel music box device that can play music for a long time and can also suppress a thickness.

The present invention relates to a music box device including: a sheet that has a playing engagement part and is rotated by a driving means; a star wheel arranged oppositely to the sheet and having two or more claws on an outer peripheral surface; and a vibration valve arranged adjacent to the star wheel. In the music box device, as the sheet is rotated by the driving means, the playing engagement part is linked with one claw to rotate the star wheel while another claw plucks the vibration valve to play music, and the sheet has a helical plate shape.

### TECHNICAL FIELD

The present invention relates to a music box device, and particularly to a music box device capable of playing music for a long time.

### BACKGROUND ART

Conventionally, as a music box device for playing music by plucking vibration valves having different scales at predetermined timings, there is known a cylinder type music box device in which pins to be engaged with individual vibration valves are provided on an outer peripheral surface of a cylinder at a predetermined pitch. In order to play music for a long time in such a cylinder type music box device, there is a problem that a thickness of the music box device becomes very thick since a diameter of the cylinder must be increased.

On the other hand, in place of a configuration in which a vibration valve is directly plucked by a pin of a cylinder, there is also known a tape type music box device (e.g., refer to Patent Literature 1) that includes a star wheel rotatably held and having a plurality of claws on an outer peripheral surface, and a tape having through holes drilled at a predetermined pitch. In this music box device, the star wheel is rotated by engaging one claw of the star wheel with the through hole along with the feeding of the tape, enabling another claw of the star wheel to pluck the vibration valve to play music. According to such a tape type music box device, increasing a length of the tape allows music to be played for a long time. There is also known a disc type music box for playing music with a circular disc instead of the above-mentioned tape (e.g., refer to Patent Literature 2)

### CITATION LIST

### Patent Literature

Patent Literature 1: JP H9-101775 A

Patent Literature 2: JP H11-15467 A

### SUMMARY OF INVENTION

### Technical Problem

Meanwhile, with such a tape type music box device, it is necessary to provide two rolls, that is, a feeding roll wound with a tape before playing, and a receiving roll to be wound with a tape after playing, leading to an increase in the number of components. Moreover, along with the feeding of the tape, a tape diameter of the feeding roll becomes smaller while a tape diameter of the receiving roll becomes larger, which requires gradual change of a rotational speed of the two rolls in order to make a feeding speed of the tape constant, leading to complication of the mechanism. Furthermore, in order to play music for a long time, the tape diameter of the roll also increases as the length of the tape increases, so that the overall thickness of the music box device has also tended to be thick in combination with an increase in the number of components and complication of the mechanism. On the other hand, since a disc type music box uses a thin disc, it is possible to reduce the overall thickness of the music box device, but there has also been limitation in extending a playing time since a music length that can be played depends on a circumferential length of the disc.

The present invention has been made to solve such problems, and an object thereof is to provide a novel music box device capable of playing music for a long time and also suppressing a thickness.

### Solution to Problem

The present invention relates to a music box device including: a sheet that has a playing engagement part and is rotated by a driving means; a star wheel arranged oppositely to the sheet and having two or more claws on an outer peripheral surface; and a vibration valve arranged adjacent to the star wheel, in which, as the sheet is rotated by the driving means, the playing engagement part is linked with one claw to rotate the star wheel, and another claw plucks the vibration valve to play music.

In this music box device, the sheet has a helical plate shape.

The driving means preferably includes a first rotary disc connected to one end of the sheet, a second rotary disc connected to another end of the sheet, and a synchronizing mechanism to synchronously rotate the first rotary disc and the second rotary disc.

The driving means includes a shaft that is rotated by a driving part and holds the star wheel to be idly rotatable; and a shaft gear that is provided on the shaft and transmits a rotational force of the shaft to a rotary-disc drive gear connected to the first rotary disc, to rotate the first rotary disc. The music box device includes a knob provided movably along a center axis of the first rotary disc and rotatable around this center axis. The knob includes a driving engaged part that is engaged with a driving engagement part provided on the first rotary disc to rotate the first rotary disc, and a shaft movement engagement part that moves the shaft together with the knob. Preferably, when the knob is moved in a direction away from the first rotary disc, the music box device is brought into a playable state where the driving engagement part and the driving engaged part are disengaged while the rotary-disc drive gear and the shaft gear are engaged with each other. Whereas, preferably, when the knob is moved in a direction to approach the first rotary disc, the music box device is brought into a sheet feeding state where the driving engagement part and the driving engaged part are engaged with each other while the shaft movement engagement part moves the shaft to disengage the rotary-disc drive gear from the shaft gear, and to separate the star wheel from the sheet.

It is preferable to provide a cover plate including a spiral groove provided facing at least one of the first rotary disc and the second rotary disc, and a pin movable in the spiral groove, and at least one of the first rotary disc and the second rotary disc facing the cover plate preferably has a radial groove extending in a radial direction and holding the pin movably.

The driving means preferably includes a shaft to integrally rotate a spacer that holds the star wheel to be idly rotatable and is provided coaxially with the star wheel. The driving means preferably further includes a sheet pressing mechanism having: a driving roller that sandwiches the sheet in between with the spacer and is rotated by the driving means to feed out the sheet; and a pressing roller that is mounted to a drive shaft to be rotated together with the driving roller, and brings the sheet toward the spacer.

Preferably, the driving roller is configured to rotate the sheet at a rotational speed consistent with the first rotary disc and the second rotary disc.

### Advantageous Effects of Invention

In the music box device according to the present invention, since a helical plate-like sheet is used as a medium to pluck the vibration valve via the star wheel, it is possible to play music for a long time. Moreover, the helical plate-like sheet allows an un-played portion and a played portion to be stacked with each other to form a layer, enabling suppression of the thickness of the music box device.

Further, when there are provided, as a driving means to rotate the sheet, the first rotary disc connected to one end of the sheet, the second rotary disc connected to another end of the sheet, and the synchronizing mechanism to synchronously rotate the first rotary disc and the second rotary disc, a local load is not applied to the sheet, and the sheet can be stably rotated since the entire sheet can be integrally rotated.

Moreover, when the music box device is provided with the above-described knob provided to be movable along the center axis of the first rotary disc and rotatable around the center axis, moving the knob in the direction away from the first rotary disc can bring the music box device into the playable state where the driving engagement part and the driving engaged part are disengaged while the rotary-disc drive gear and the shaft gear are engaged with each other. Whereas, moving the knob in the direction to approach the first rotary disc can bring the music box device into the sheet feeding state where the driving engagement part and the driving engaged part are engaged with each other, the rotary-disc drive gear and the shaft gear are disengaged, and the star wheel moves away from the sheet. That is, moving the knob in the direction away from the first rotary disc allows music to be played as usual, and moving the knob in the direction to approach the first rotary disc and rotating enables fast forwarding and rewinding of the sheet at a high speed.

Further, when there are provided the cover plate including the spiral groove provided facing at least one of the first rotary disc and the second rotary disc, and the pin movable in the spiral groove, and at least one of the first rotary disc and the second rotary disc facing the cover plate is provided with the radial groove extending in the radial direction and holding the pin movably, it is possible to grasp progress of the music being played, with the position of the pin since the pin also moves along with the rotation of the sheet.

When the driving means is provided with the shaft to integrally rotate the spacer that holds the star wheel to be idly rotatable and is provided coaxially with the star wheel, and the driving means is provided with the sheet pressing mechanism having: the driving roller that sandwiches the sheet in between with the spacer and is rotated by the driving means to feed out the sheet; and the pressing roller that is mounted to the drive shaft to be rotated together with the driving roller, and brings the sheet toward the spacer, the sheet can be rotated more stably since the sheet can be fed out by the spacer and the driving roller. Further, although a speed is different between an inner side and an outer side in the radial direction since the sheet has a disc shape in a plan view, wrinkles or twists do not occur in the sheet since the driving roller is only the roller to feed out the sheet while the pressing roller does not positively feed out the sheet.

Moreover, since it is possible to synchronously rotate all of the first rotary disc, the second rotary disc, and the sheet by configuring the driving roller to rotate the sheet at a rotational speed consistent with the first rotary disc and the second rotary disc, no extra load is applied to the sheet.

### BRIEF DESCRIPTION OF DRAWINGS

FIG. 1 is an exploded perspective view schematically showing individual components (excluding a sheet and the like) relating to one embodiment of a music box device according to the present invention.

FIG. 2 is a perspective view showing a state where the components (including the sheet) shown in FIG. 1 are partially assembled.

FIG. 3 is a cross-sectional view of the music box device shown in FIG. 1 in a side view.

FIG. 4 is a schematic view along an arrow A shown in FIG. 2.

FIG. 5 is a cross-sectional view taken along line B-B shown in FIG. 3.

FIG. 6 is a plan view showing a radial groove and a spiral groove.

FIG. 7 is a cross-sectional view showing a state where a knob is depressed downward from a state shown in FIG. 3.

FIG. 8 is a view showing an arrow view along an arrow C shown in FIG. 7 by superposing views before depressing the knob (virtual line) and after depressing (solid line), in which FIG. 8(a) is a view showing a relationship of a shaft depression assisting mechanism, and FIG. 8(b) is a view showing a relationship of a driving means.

FIG. 9 is a cross-sectional view in a side view showing another embodiment of the music box device according to the present invention.

FIG. 10 is a cross-sectional view taken along line D-D shown in FIG. 9.

FIG. 11 is a partially enlarged view of FIG. 10, in which FIG. 11(a) shows a part E and FIG. 11(b) shows a part F.

FIG. 12 is a cross-sectional view showing a playable state of the music box device shown in FIG. 9, in which FIG. 12(a) is a cross-sectional view taken along line a-a shown in FIG. 11, FIG. 12(b) is a cross sectional view taken along line b-b shown in FIG. 11, FIG. 12(c) is a cross-sectional view taken along line c-c shown in FIG. 11, and FIG. 12(d) is a cross sectional view taken along line d-d shown in FIG. 11.

FIG. 13 is a cross-sectional view showing the playable state of the music box device shown in FIG. 9, in which FIG. 13(a) is a cross-sectional view taken along line e-e shown in FIG. 11, and FIG. 13(b) is a cross sectional view taken along line f-f shown in FIG. 11.

FIG. 14 is a cross-sectional view showing a sheet feeding state of the music box device shown in FIG. 9, in which FIG. 14(a) is a cross-sectional view taken along line a-a shown in FIG. 11, FIG. 14(b) is a cross sectional view taken along line b-b shown in FIG. 11, FIG. 14(c) is a cross-sectional view taken along line c-c shown in FIG. 11, and FIG. 14(d) is a cross sectional view taken along line d-d shown in FIG. 11.

FIG. 15 is a cross-sectional view showing the sheet feeding state of the music box device shown in FIG. 9, in which FIG. 15(a) is a cross-sectional view taken along line e-e shown in FIG. 11, and FIG. 15(b) is a cross sectional view taken along line f-f shown in FIG. 11.

### DESCRIPTION OF EMBODIMENTS

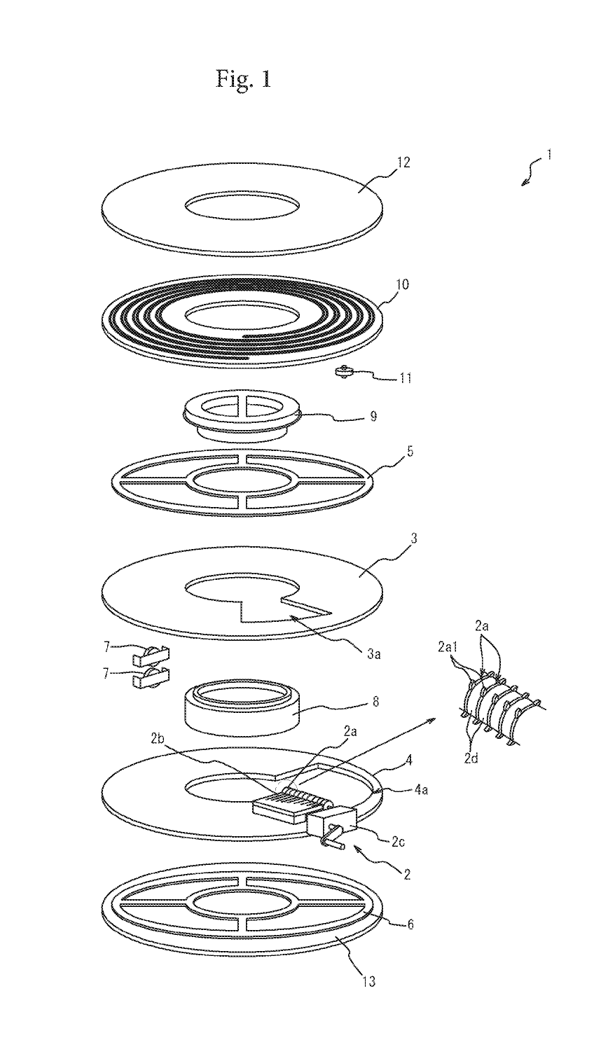

Hereinafter, an embodiment of a music box device according to the present invention will be described with reference to the drawings. In this specification, “upper” is a side on which a protective plate (reference numeral 12) is located with respect to a bottom plate (reference numeral 13) in FIG. 1, and “lower” is a side opposite to the upper side.

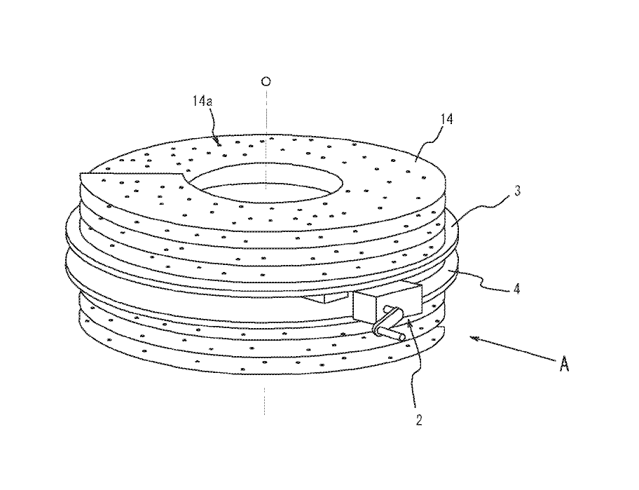

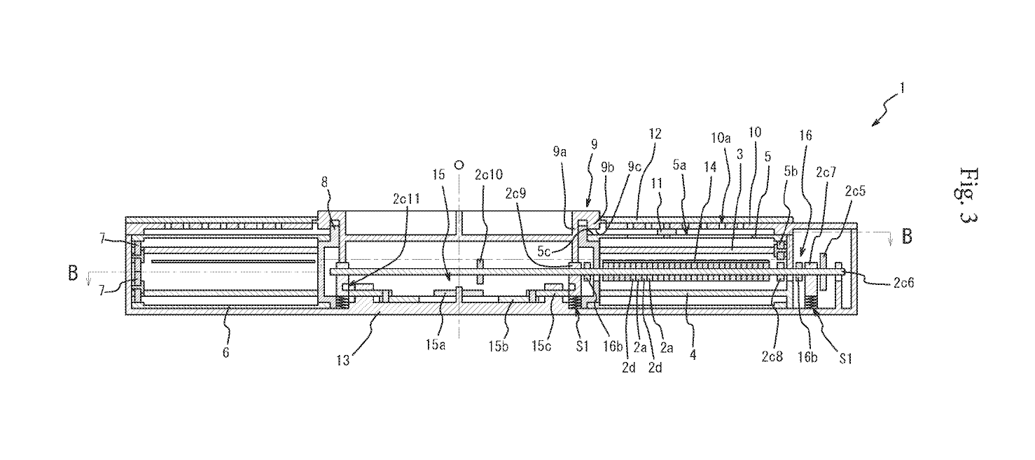

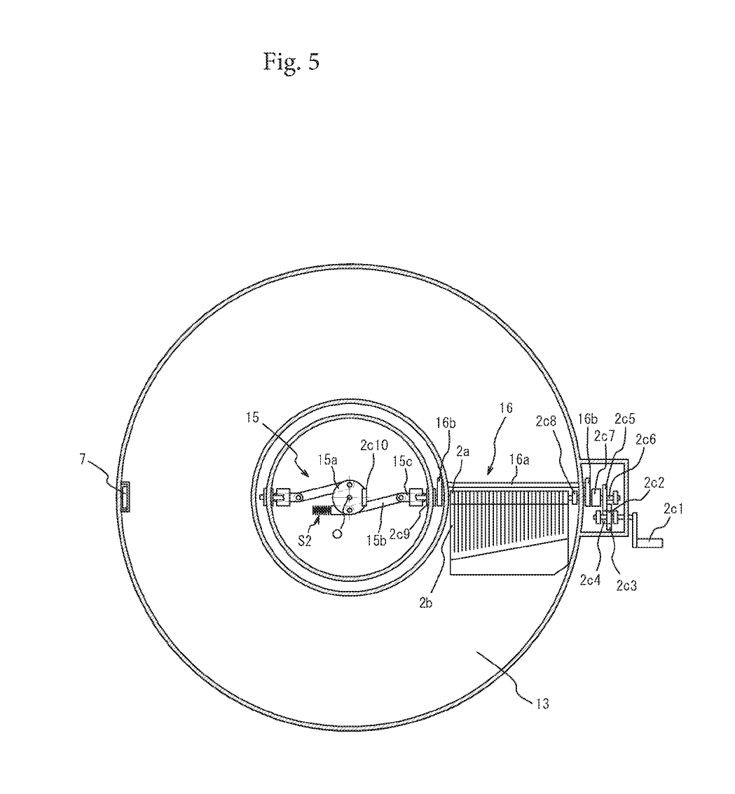

In the drawings, reference numeral 1 indicates the music box device of the present embodiment. As schematically shown in FIG. 1, the music box device 1 includes: a music box body 2; an upper partition plate 3; a lower partition plate 4; an upper rotary disc (first rotary disc) 5; a lower rotary disc (second rotary disc) 6; a synchronizing gear 7; a connecting member 8; a knob 9; a top plate (cover plate) 10; a pin 11; the protective plate 12; and the bottom plate 13. Although not shown in FIG. 1, the music box device 1 further includes a sheet 14 as shown in FIG. 2. Furthermore, the music box device 1 includes a lock mechanism 15 shown in FIGS. 3 and 5, and a shaft depression assisting mechanism 16.

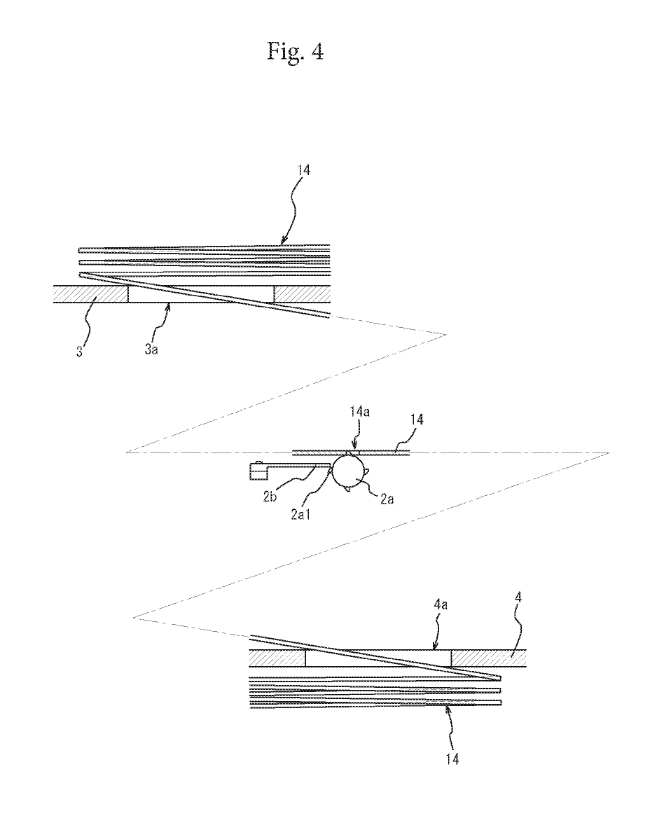

As shown in FIG. 1, the music box body 2 includes: a plurality of star wheels 2a arranged along a center axis; a plurality of vibration valves 2b arranged adjacently to the star wheels 2a and aligned at positions corresponding to the respective star wheels 2a; and a driving means 2c to apply a rotational force to the sheet 14. As shown in FIG. 4, the star wheel 2a includes two or more claws 2a1 on its outer peripheral surface. Moreover, as shown in FIG. 1, a disc-like spacer 2d is provided coaxially with the star wheels 2a, between the adjacent star wheels 2a.

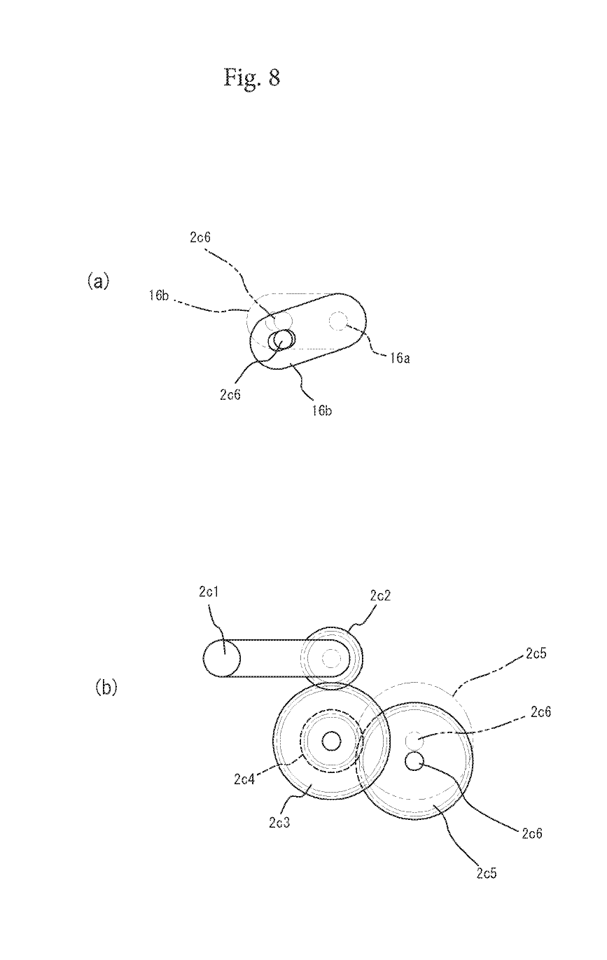

Further, as shown in FIGS. 5 and 8(b), the driving means 2c includes: a handle 2c1 to be rotated by hand; and a first gear 2c2 to transmit a rotational force of the handle 2c1, and further includes a shaft 2c6 that is rotated via three gears (a second gear 2c3, a third gear 2c4, and a fourth gear 2c5) (the fourth gear 2c5 and the shaft 2c6 are rotated integrally). As shown in FIGS. 3 and 5, the shaft 2c6 extends long from the outer side toward the inner side in the radial direction of the music box device 1. Further, the shaft 2c6 includes a columnar first support part 2c7 supporting the shaft 2c6 rotatably near the fourth gear 2c5, and a shaft gear 2c8 that is rotated integrally with the shaft 2c6, and the shaft 2c6 holds the plurality of star wheels 2a so as to skewer the star wheels 2a to be idle rotatable. While the shaft 2c6 holds the star wheels 2a together with the spacer 2d so as to skewer, the spacer 2d is attached to the shaft 2c6 by a means such as an interference fit and rotated integrally with the shaft 2c6. Further, the shaft 2c6 is rotatably supported by a pair of second support parts 2c9 that become columnar at a center part of the music box device 1, and a locking gear 2c10 to be rotated integrally with the shaft 2c6 is provided between the second support parts 2c9. Here, each of the second support parts 2c9 includes a recess 2c11 that is concaved from the radially inner side to the outer side on a surface facing a center axis O of the music box device 1. Note that the recess 2c11 may be a through hole penetrating the second support part 2c9. Then, as shown in FIG. 3, a spring S1 is provided under the first support part 2c7 and the pair of second support parts 2c9, and an urging force is applied to the shaft 2c6 from bottom to top. While the fourth gear 2c5 is movable in a vertical direction together with the shaft 2c6, even when the shaft 2c6 is lowered as shown in FIG. 8(b), the fourth gear 2c5 and the third gear 2c4 mesh with each other.

As shown in FIG. 1, the upper partition plate 3 is provided above the driving means 2c, and a hole 3a is provided inside the driving means 2c. The lower partition plate 4 is provided below the driving means 2c, and a hole 4a is provided inside the lower partition plate 4.

As shown in FIG. 2, the sheet 14 is formed in a helical plate shape extending so as to turn around the center axis O of the music box device 1. The sheet 14 of the present embodiment is made of a thin plastic, but is not limited to this material. Further, the sheet 14 of the present embodiment is formed in the helical plate shape by radially cutting a sheet formed in a doughnut shape in advance, and joining the plurality of the cut sheets together, but the forming method is not limited to this. Here, there are provided a plurality of playing engagement parts 14a that are engaged with the claws 2a1 of the star wheel 2a when the sheet 14 is rotated, at predetermined positions on the sheet 14. The playing engagement parts 14a of the present embodiment are through holes penetrating the sheet 14, but may be protrusions protruding toward the claw 2a1.

Then, as shown in FIG. 4, an upper portion of the sheet 14 is stacked and placed so as to form a layer on the upper partition plate 3, and passes through the hole 3a and over the star wheel 2a to reach the hole 4a of the lower partition plate 4. A lower portion of the sheet 14 having passed through the hole 4a is stacked and placed so as to form a layer below the lower partition plate 4.

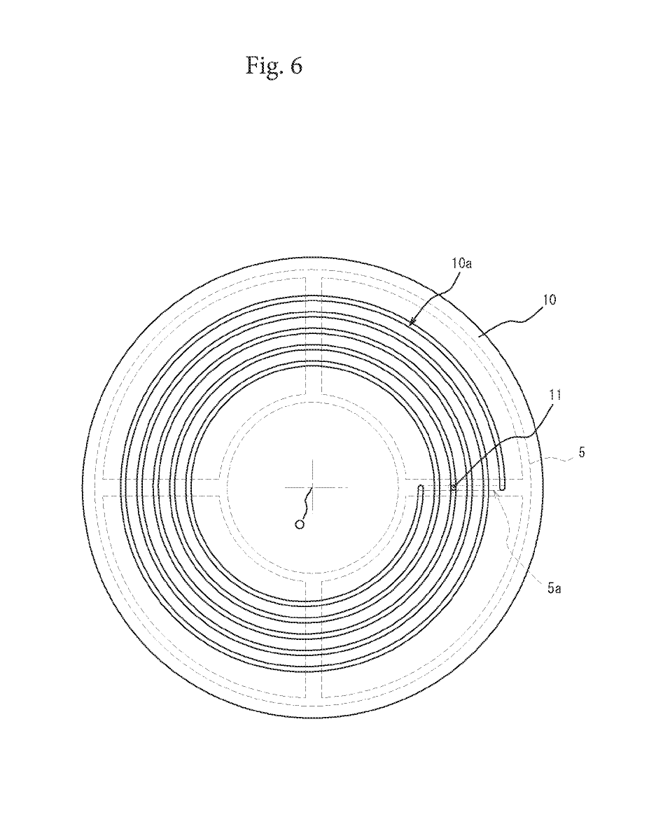

Although not shown, an upper end portion of the sheet 14 is connected to the upper rotary disc (first rotary disc) 5 located above the upper partition plate 3 as shown in FIGS. 1 and 3, while a lower end portion of the sheet 14 is connected to the lower rotary disc (second rotary disc) 6 located below the lower partition plate 4. The upper rotary disc 5 and the lower rotary disc 6 of the present embodiment have a shape in which a small-diameter doughnut-shaped portion located at the center part and a large-diameter doughnut-shaped portion located radially outward are connected by a total of four frames extending in the radial direction. In addition, as shown in FIG. 6, one frame of the upper rotary disc 5 is provided with a radial groove 5a penetrating the frame and extending in the radial direction. Although detailed description of the configuration is omitted, the upper rotary disc 5 and the lower rotary disc 6 are supported so as to rotate with respect to the upper partition plate 3 and the lower partition plate 4.

As shown in FIG. 3, below the upper rotary disc 5, there is provided a rotary-disc drive gear 5b that is rotatably supported by the upper partition plate 3 and rotated by the shaft gear 2c8. Here, uneven teeth (not shown) to be engaged with the rotary-disc drive gear 5b are provided on a lower surface of the upper rotary disc 5 on the radially outer side, and the upper rotary disc 5 is rotated via the rotary-disc drive gear 5b when the shaft gear 2c8 rotates. In FIG. 3, the shaft gear 2c8 and the rotary-disc drive gear 5b are illustrated separately. However, a gear (not shown) is provided between the shaft gear 2c8 and the rotary-disc drive gear 5b, and the shaft gear 2c8 and the rotary-disc drive gear 5b indirectly mesh with each other in the state shown in FIG. 3 (a state where the shaft 2c6 is urged upward by the spring S1). Furthermore, as shown in FIG. 3, the upper rotary disc 5 also includes uneven teeth (driving engagement part 5c) on an upper surface on the radially inner side.

Further, between the upper rotary disc 5 and the lower rotary disc 6, a synchronizing mechanism to synchronously rotate these discs is provided. In the present embodiment, as shown in FIGS. 1 and 3, two synchronizing gears 7 are provided, and one of the synchronizing gears 7 meshes with uneven teeth (not shown) meshing with the above-mentioned rotary-disc drive gear 5b, while another synchronizing gear 7 meshes with teeth (not shown) provided on an upper surface of the lower rotary disc 6 on the radially outer side. As a result, when the upper rotary disc 5 rotates, the lower rotary disc 6 can also synchronously rotate. Note that the synchronizing mechanism is not limited to the synchronizing gear 7, but the upper rotary disc 5 may be connected to the lower rotary disc 6 via, for example, a toothed belt (which may also be a toothless belt).

As shown in FIG. 1, the connecting member 8 having a substantially cylindrical shape is provided on the radially inner side of the upper rotary disc 5 and the lower rotary disc 6. The connecting member 8 is connected to the upper partition plate 3 and the lower partition plate 4, while rotatably supporting the upper rotary disc 5 and the lower rotary disc 6.

The knob 9 is provided above the connecting member 8 as shown in FIGS. 1 and 3. The knob 9 of the present embodiment forms a shape in which a disc-shaped portion including a plate-shaped portion extending upward is connected to inside a small-diameter cylindrical portion 9a, and a large-diameter cylindrical portion 9b extending downward is connected to an outer end of a flange connected to an upper end of the small-diameter cylindrical portion 9a. In the knob 9, a lower end of the small-diameter cylindrical portion 9a abuts against an upper end of the second support part 2c9, while an outer surface of the small-diameter cylindrical portion 9a is in contact with an inner surface of the connecting member 8, and the knob 9 is supported to be vertically movable along the center axis O and rotatable around the center axis O. Here, when the knob 9 is depressed, the small-diameter cylindrical portion 9a depresses the second support part 2c9, so that the shaft 2c6 also moves downward (the small-diameter cylindrical portion 9a functions as a shaft movement engagement part that moves the shaft 2c6). Although not shown, since the knob 9 moves with respect to the second support part 2c9 and the connecting member 8, in order to lower friction (sliding resistance) therebetween, it is preferable that the lower end of the small-diameter cylindrical portion 9a and the upper end of the second support part 2c9 are made arcuate, or small protrusions are provided at a contacting portion, for example.

Although not shown in detail, at a lower end of the large-diameter cylindrical portion 9b, the knob 9 includes a driving engaged part 9c to be engaged with the driving engagement part 5c that is uneven teeth provided on the upper rotary disc 5. As a result, when the knob 9 is depressed and rotated, the driving engagement part 5c and the driving engaged part 9c mesh with each other, so that the upper rotary disc 5 can be rotated.

Then, the top plate (cover plate) 10 is provided above the upper rotary disc 5 as shown in FIGS. 1 and 3. As shown in FIG. 6, the top plate 10 is provided with a spiral groove 10a penetrating the top plate 10 and extending in a spiral shape around the center axis O.

Further, between the upper rotary disc 5 and the top plate 10 as shown in FIGS. 1 and 3, there is provided the pin 11 having a large-diameter cylindrical shape at a center part and a small-diameter cylindrical shape at a top and bottom. As shown in FIGS. 3 and 6, the pin 11 is accommodated in the radial groove 5a and the spiral groove 10a, and moves radially inward or outward in accordance with the rotation of the upper rotary disc 5.

Moreover, the protective plate 12 is provided above the top plate 10. Since the protective plate 12 covers the spiral groove 10a, entering of dust and the like to the music box device 1 can be prevented. Further, the protective plate 12 of the present embodiment is transparent, so that a position of the pin 11 can be seen from outside.

The bottom plate 13 together with the top plate 10 and the protective plate 12 forms a casing of the music box device 1, and accommodates the above-described members inside as shown in FIG. 3.

The lock mechanism 15 shown in FIGS. 3 and 5 is for maintaining the shaft 2c6 at a lower position when the knob 9 is depressed. In the present embodiment, the lock mechanism 15 includes: a disc 15a rotatably held at a center part of the bottom plate 13; a pair of levers 15b axially supported by the disc 15a; a spring S2 to apply an urging force to the levers 15b toward the radially outer side; and a lock member 15c axially supported by the levers 15b and having a tip inserted into the recess 2c11 of the second support part 2c9. Here, on an upper surface of the disc 15a, uneven teeth (not shown) are provided to mesh with the locking gear 2c10 provided on the shaft 2c6 when the knob 9 is depressed. Then, in a state where the teeth of the locking gear 2c10 mesh with the teeth of the disc 15a, when the locking gear 2c10 rotates along with the rotation of the shaft 2c6, the disc 15a rotates so as to return the lock member 15c radially inward.

The shaft depression assisting mechanism 16 shown in FIGS. 3 and 5 is for assisting such that the shaft 2c6 is entirely lowered (in particular, a portion provided with the fourth gear 2c5 and the like distant from the knob 9) when the knob 9 is depressed. The shaft depression assisting mechanism 16 of the present embodiment includes a second shaft 16a extending in parallel with the shaft 2c6, and includes a pair of arms 16b having long holes inserted with the shaft 2c6 at both ends of the second shaft 16a, and shaft depression assisting mechanism 16 is formed in a U-shape as a whole. Although not shown, the second shaft 16a is swingably supported by a support part provided on the bottom plate 13. Therefore, as shown in FIG. 8(a), both of the arms 16b can be moved at a same angle.

In the music box device 1 having such a configuration, as shown in FIG. 3, music can be played in a state where the knob 9 is located above (playable state). To play music, firstly the handle 2c1 is turned by hand. This causes sequential rotation of the first gear 2c2, the second gear 2c3, and the third gear 2c4, and rotation of the shaft 2c6 and the shaft gear 2c8 together with the fourth gear 2c5, to rotate the upper rotary disc 5 via the rotary-disc drive gear 5b. At this time, since the lower rotary disc 6 is synchronously rotated together with the upper rotary disc 5 by the synchronizing gear 7, the helical plate-like sheet 14 having the upper end portion and the lower end portion connected to the upper rotary disc 5 and the lower rotary disc 6 is also synchronously rotated. That is, the sheet 14 can be stably rotated without applying a local load to the sheet 14.

When the sheet 14 is rotated, as shown in FIG. 4, the upper portion (un-played portion) of the helical plate-like sheet 14 placed on the upper partition plate 3 passes through the hole 3a and over the star wheel 2a. Accordingly, the playing engagement part 14a is linked with one claw 2a1 of the star wheel 2a to rotate the star wheel 2a, and another claw 2a1 plucks the vibration valve 2b to allow a sound to be made. Since the sheet 14 has the helical plate shape and a long overall length, music can be played for a long time. Then, the lower portion (played portion) of the sheet 14 having passed through the star wheel 2a passes through the hole 4a to be placed below the lower partition plate 4. Thus, in the sheet 14, the un-played portion and the played portion can be stacked to form a layer above the upper partition plate 3 and below the lower partition plate 4, enabling suppression of the thickness of the music box device 1.

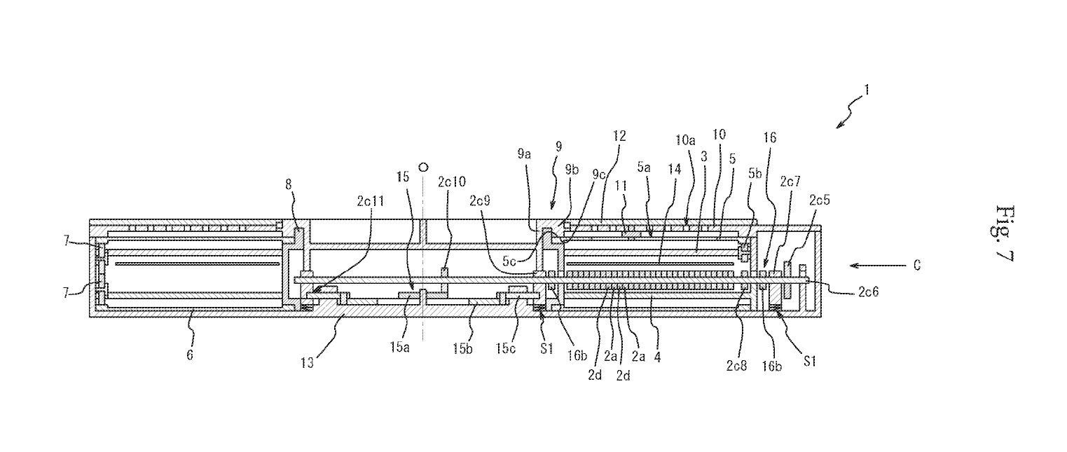

Further, as shown in FIG. 7, depressing the knob 9 downward can maintain a state (sheet feeding state) in which the sheet 14 can be fast forwarded or rewound. That is, since the knob 9 lowers the second support part 2c9 against the spring S1, the lock member 15c urged by the spring S2 shown in FIG. 5 is inserted into the recess 2c11. Then, the shaft 2c6 is also lowered together with the second support part 2c9, the shaft gear 2c8 held by the shaft 2c6 is separated from the rotary-disc drive gear 5b, and the star wheel 2a is separated from the sheet 14. Whereas, since the driving engaged part 9c of the knob 9 is engaged with the driving engagement part 5c of the upper rotary disc 5, the sheet 14 can be fast forwarded or rewound at a high speed along with the rotation of the knob 9.

Since the shaft 2c6 extends long in the radial direction, a portion provided with the fourth gear 2c5 or the like on the radially outer side may not be evenly depressed even when the knob 9 is depressed. However, in the present embodiment, since the arms 16b provided at both ends of the second shaft 16a can also apply a force to the radially outer portion of the shaft 2c6, the shaft 2c6 can be horizontally depressed.

The pin 11 of the present embodiment is configured to move from the radially outer side to the inner side along the radial groove 5a as the playing of the sheet 14 progresses. That is, since the position of the pin 11 shows the playing process of the sheet 14, for example, marking the protective plate 12 for each start of music enables the start of the music to be found by feeding the sheet 14 so as to match the pin 11 with the mark.

Although music cannot be played in a state where the knob 9 is depressed downward, turning the handle 2c1 also rotates the shaft 2c6 since the third gear 2c4 and the fourth gear 2c5 mesh with each other even in this state as described above. At this time, as shown in FIG. 7, the disc 15a and the locking gear 2c10 mesh with each other, and the locking gear 2c10 and the disc 15a are also rotated along with the rotation of the shaft 2c6 to cause the lock member 15c to be returned radially inward, which releases the linkage between the second support part 2c9 and the lock member 15c, and causes the knob 9 to be automatically returned upward by the urging force of the spring S1. That is, even when the knob 9 is depressed downward, it is unnecessary to move the knob 9 upward, but the playable state can be restored by simply turning the handle 2c1 for playing music as usual.

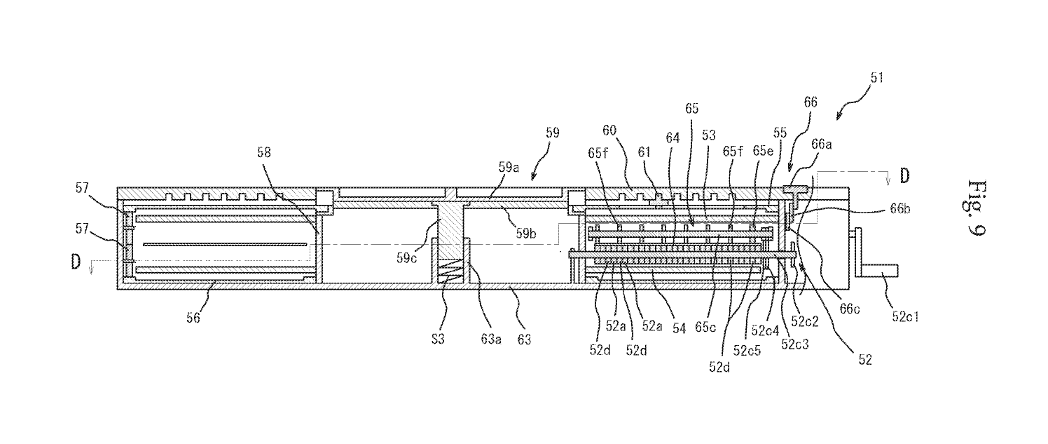

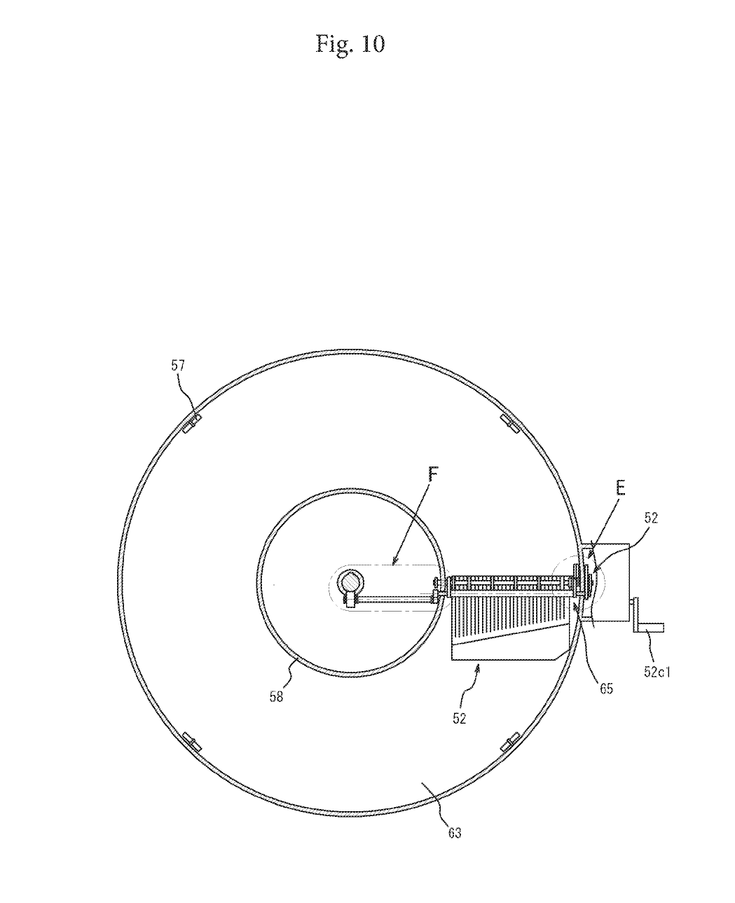

Next, another embodiment of the music box device according to the present invention will be described with reference to FIGS. 9 to 15. A music box device 51 of the present embodiment includes: a music box body 52; an upper partition plate 53; a lower partition plate 54; an upper rotary disc (first rotary disc) 55; a lower rotary disc (second rotary disc) 56; a synchronizing gear 57; a connecting member 58; a knob 59; a top plate (cover plate) 60; a pin 61; a bottom plate 63; and a sheet 64. Further, the music box device 51 includes a sheet pressing mechanism 65 shown in FIGS. 9 and 10, and a mode switching mechanism 66. Note that the upper partition plate 53, the lower partition plate 54, the upper rotary disc 55, the lower rotary disc 56, the synchronizing gear 57, the connecting member 58, the pin 61, and the sheet 64 have substantially the same configuration as that of the upper partition plate 3, the lower partition plate 4, the upper rotary disc 5, the lower rotary disc 6, the synchronizing gear 7, the connecting member 8, the pin 11, and the sheet 14 in the above-described music box device 1, so that detailed description will be omitted.

The music box body 52 includes a star wheel (reference numeral 52a in FIG. 9), a vibration valve (reference numeral omitted), and a driving means (reference numeral omitted). Note that the star wheel 52a and the vibration valve have substantially the same form as that of the music box body 2 described above, but a configuration of the driving means is partially different from the driving means 2c described above. The driving means of the present embodiment is configured such that a rotational force of the handle 52c1 shown in FIG. 9 is transmitted to a first drive gear 52c2 via a gear (not shown). Here, the first drive gear 52c2 is provided on a shaft 52c3 that holds a plurality of the star wheels 52a so as to skewer the star wheels 52a to be idly rotatable. Moreover, between adjacent star wheels 52a, as in the above-mentioned spacer 2d, there is provided a spacer 52d that forms a disc shape and is rotated integrally with the shaft 52c3. Further, on the shaft 52c3, there are provided a second drive gear 52c4 and a third drive gear 52c5 that are rotated integrally with the shaft 52c3. Although the shaft 2c6 in the above-described embodiment is movable in the vertical direction, the shaft 52c3 of the present embodiment is configured not to move in the vertical direction.

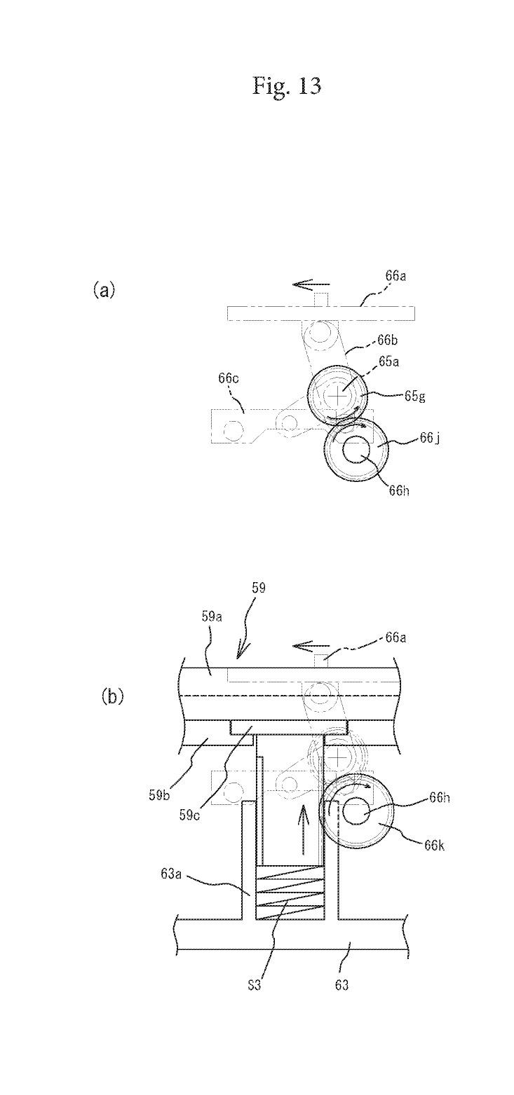

The knob 59 includes: an upper knob part 59a serving as a portion to be picked by fingers; a plate-shaped lower knob part 59b having a hole in a center part; and a knob shaft part 59c inserted through the hole of the lower knob part 59b and sandwiched between the upper knob part 59a and the lower knob part 59b. Moreover, a rack is provided on a side surface of the knob shaft part 59c as shown in FIG. 13(b). Although not shown, the knob 59 is provided with a portion corresponding to the above-described driving engaged part 9c to fast forward or rewind the upper rotary disc 55.

The top plate 60 has such a form that the top plate 10 and the protective plate 12 in the above-described embodiment are integrated. Although the top plate 60 may be entirely transparent, it is preferable that only a spiral groove in which the pin 61 moves is made transparent while the other parts are colored, in appearance.

The bottom plate 63 has a cylindrical portion 63a at a center part. The cylindrical portion 63a holds the knob shaft part 59c slidably. Further, the cylindrical portion 63a is provided with a spring S3 that urges the knob shaft part 59c upward.

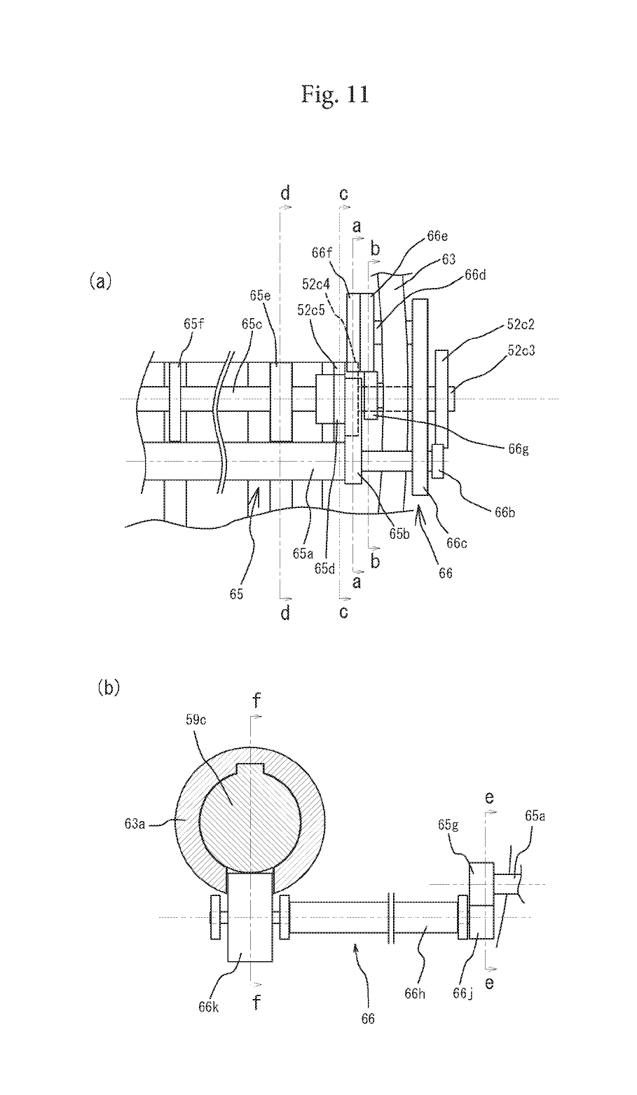

The sheet pressing mechanism 65 is provided on an opposite side to the star wheel 52a and the spacer 52d with the sheet 64 interposed therebetween, and sandwiches the sheet 64 in between with the spacer 52d to feed out the sheet 64. As shown in FIGS. 9, 11(a), and 12(c), the sheet pressing mechanism 65 of the present embodiment includes: a swing shaft 65a provided to be swingable with respect to the mode switching mechanism 66; an arm 65b integrally connected to the swing shaft 65a; a drive shaft 65c rotatably held by the arm 65b; a shaft gear 65d to be rotated integrally with the drive shaft 65c; a driving roller 65e that is rotated integrally with the drive shaft 65c and sandwiches the sheet 64 in between with the spacer 52d to feed out the sheet 64; and a pressing roller 65f mounted on the drive shaft 65c to bring the sheet 64 toward the spacer 52d. In other words, the pressing roller 65f does not have a function of positively feeding out the sheet 64 while bringing the sheet 64 close toward the spacer 52d. In order not to provide such a function to the pressing roller 65f, for example, while the pressing roller 65f is configured to be rotated integrally with the drive shaft 65c, a diameter of the pressing roller 65f may be made smaller than a diameter of the driving roller 65e. Further, even if the diameter is the same as that of the driving roller 65e, the pressing roller 65f may be configured to be idly rotated with respect to the drive shaft 65c. Further, the pressing roller 65f may have a same width as the driving roller 65e, but the width is preferably made narrower than that of the driving roller 65e as shown in FIG. 11(a) in order not to positively feed out the sheet 64. Further, the swing shaft 65a includes a shaft gear 65g as shown in FIG. 11(b).

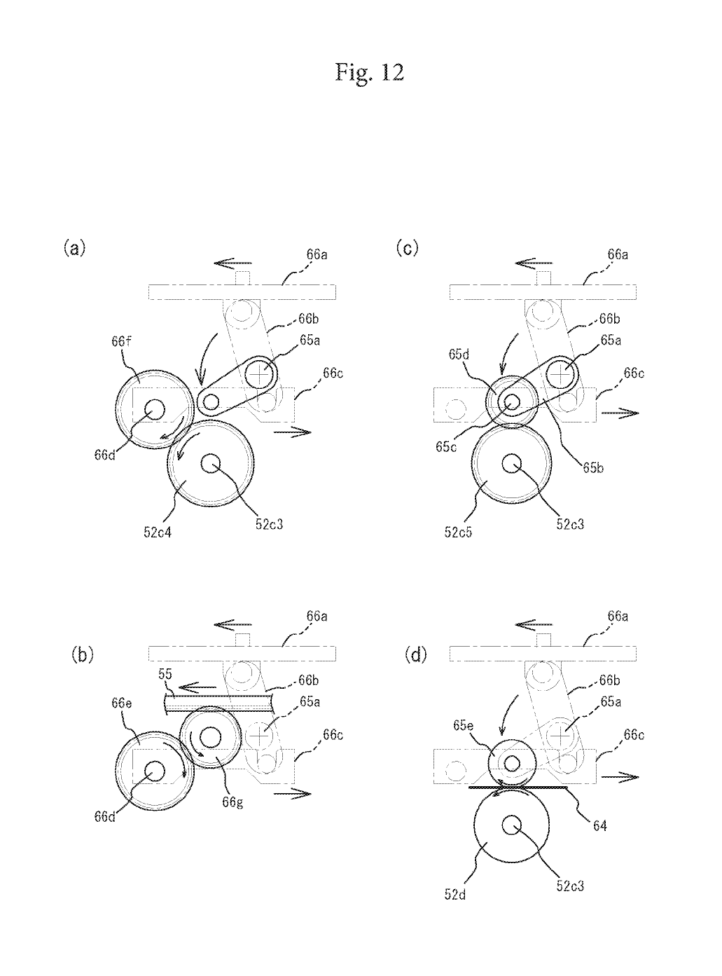

The mode switching mechanism 66 switches between the playable state and the sheet feeding state described in the above embodiment. As shown in FIGS. 9, 11(a), and 12(a), the mode switching mechanism 66 of the present embodiment includes: a slide switch 66a that moves along a top surface of the top plate 60; a first link 66b provided to be rotatable around the swing shaft 65a; and a second link 66c provided movably in a horizontal direction. The second link 66c is provided with a shaft 66d, and the shaft 66d is provided with a first switching gear 66e. The first switching gear 66e is provided with a second switching gear 66f that is rotated integrally with the first switching gear 66e. As shown in FIGS. 11(a) and 12(b), an idler 66g attached to a wall rising from the bottom plate 63 is provided beside the first switching gear 66e. A rotary-disc drive gear similar to the rotary-disc drive gear 5b provided on the above-mentioned upper rotary disc 5 is provided on an outer edge of the upper rotary disc 55, and the idler 66g meshes with this rotary-disc drive gear.

Further, as shown in FIG. 11(b), the mode switching mechanism 66 includes a switching shaft 66h. At one end of the switching shaft 66h, a third switching gear 66j to mesh with the shaft gear 65g is provided. Further, at the other end of the switching shaft 66h, a fourth switching gear 66k is provided. Here, as shown in FIG. 13(b), the fourth switching gear 66k meshes with the rack of the knob shaft part 59c.

In the music box device 51 having such a configuration, when the slide switch 66a is moved in a direction of an arrow (left side) shown in FIG. 12(a) in order to bring the music box device 51 into the playable state, the first link 66b is rotated counterclockwise around the swing shaft 65a, and the second link 66c moves to the right side. At this time, the second switching gear 66f meshes with the second drive gear 52c4, while the first switching gear 66e meshes with the idler 66g as shown in FIG. 12(b). Therefore, the rotational force of the handle 52c1 is transmitted to the upper rotary disc 55 via the idler 66g, to cause rotation of the upper rotary disc 55. Further, since the lower rotary disc 56 is also rotated via the synchronizing gear 57 when the upper rotary disc 55 is rotated, the sheet 64 connected to these is also rotated.

Furthermore, in this state, as shown in FIG. 12(c), since the arm 65b connected to the swing shaft 65a is also rotated counterclockwise, the shaft gear 65d meshes with the third drive gear 52c5. Therefore, the rotational force of the handle 52c1 is transmitted to the drive shaft 65c via the shaft gear 65d, to also cause rotation of the driving roller 65e as shown in FIG. 12(d). This causes the sheet 64 sandwiched between the spacer 52d and the driving roller 65e to be fed out by both of the spacer 52d and the driving roller 65e, enabling stable rotation of the sheet 64. Further, as shown in FIGS. 9 and 11(a), a plurality of pressing rollers 65f are provided on the drive shaft 65c, and the entire area in the radial direction of the sheet 64 is brought toward the spacer 52d by the driving roller 65e and the pressing roller 65f. That is, since the sheet 64 is also brought close to the star wheel 52a adjacent to the spacer 52d, the claw provided on the star wheel 52a can be reliably meshed with the playing engagement part provided on the sheet 64, so that music can be played as expected. Meanwhile, since the sheet 64 is circular in a plan view, a speed is different between the inner side and the outer side in the radial direction. Therefore, if a configuration is adopted in which the pressing roller 65f also applies a driving force similarly to the driving roller 65e, the configuration is required to be such that a rotational speed corresponding to the radial position of the sheet 64 is given to each of the rollers, in order to avoid wrinkles on the sheet 64 and twists of the sheet 64. However, in the present embodiment, the one driving roller 65e is the only roller to apply the driving force to the sheet 64, and the other pressing roller 65f has a smaller diameter and a smaller width than the driving roller 65e, preventing the pressing roller 65f from applying an unnecessary load to the sheet 64. This can prevent wrinkles and twists of the sheet 64 with a simple structure. In the present embodiment, a speed of the idler 66g on a circumference of a pitch circle is set to be (radial length from the center axis of the upper rotary disc 55 to the idler 66g)/(radial length from the center axis of the upper rotary disc 55 to the driving roller 65e) with respect to a speed of the driving roller 65e on a circumference. That is, since the rotational speed of the upper rotary disc 55 and the lower rotary disc 56 is equal to the rotational speed of the sheet 64, they can be rotated in synchronization.

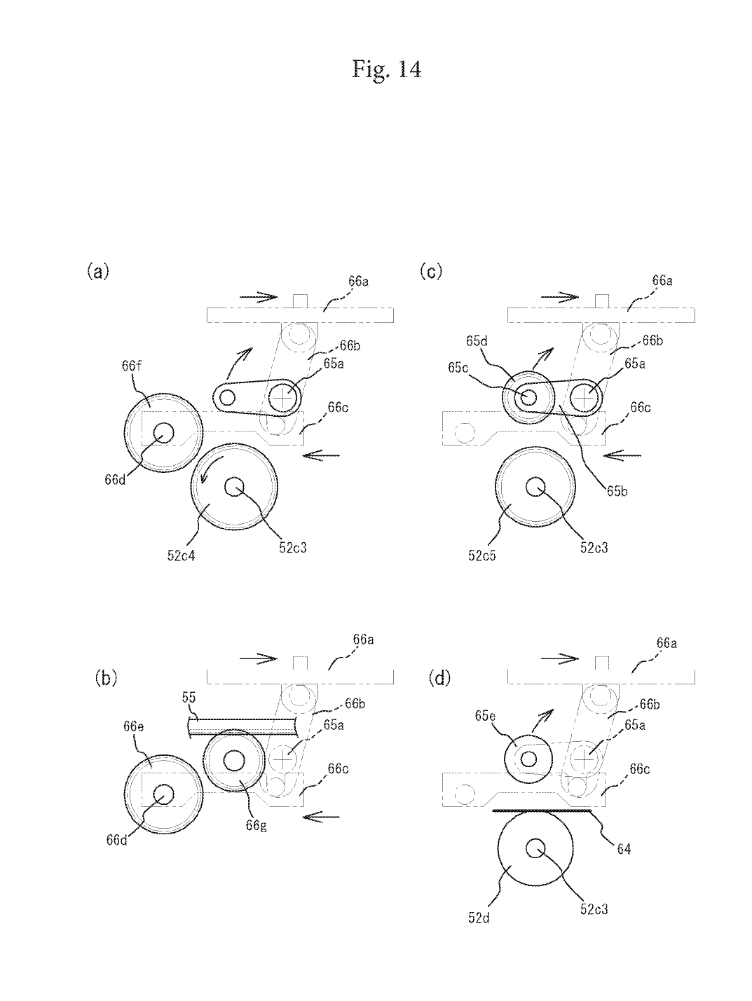

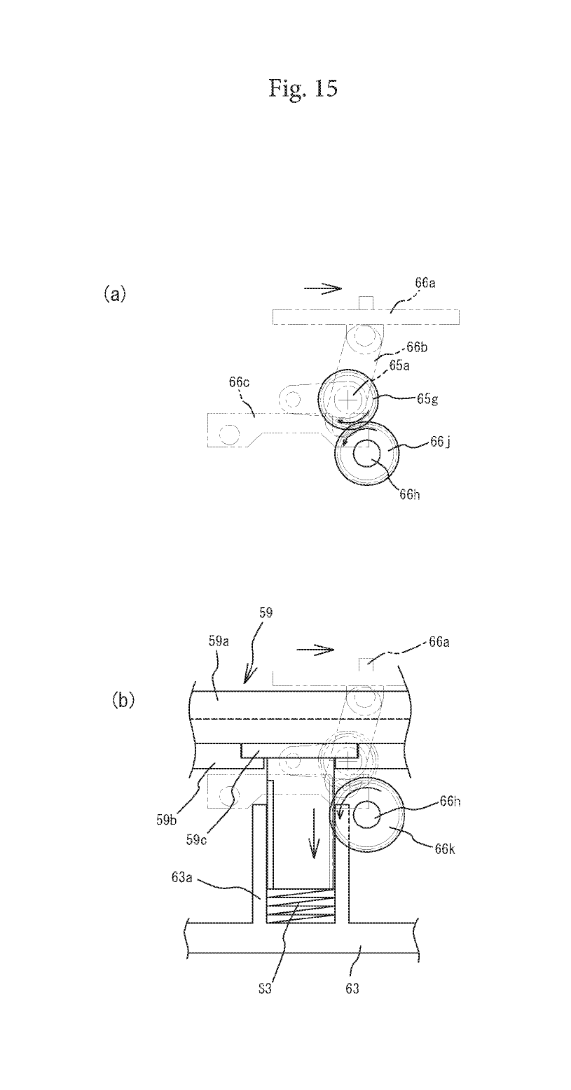

Further, in this state, as shown in FIG. 13(a), since the shaft gear 65g connected to the swing shaft 65a is rotated counterclockwise while the third switching gear 66j meshing with the shaft gear 65g is rotated clockwise, the fourth switching gear 66k connected to the third switching gear 66j via the switching shaft 66h is also rotated clockwise as shown in FIG. 13(b). Here, since the knob 59 has the knob shaft part 59c having the rack meshing with the fourth switching gear 66k, the knob 59 moves up to a standby position above.

Whereas, in order to bring the music box device into the sheet feeding state, the slide switch 66a is moved in the direction of an arrow (right side) shown in FIG. 14(a). As a result, the first link 66b is rotated clockwise around the swing shaft 65a, and the second link 66c moves to the left side. At this time, the second switching gear 66f moves away from the second drive gear 52c4, while the first switching gear 66e also moves away from the idler 66g as shown in FIG. 14(b). Furthermore, in this state, as shown in FIG. 14(c), since the arm 65b connected to the swing shaft 65a is also rotated clockwise, the shaft gear 65d also moves away from the third drive gear 52c5, and the driving roller 65e also moves away from the star wheel 52a as shown in FIG. 14(d). That is, the rotational force of the handle 52c1 is not transmitted to the upper rotary disc 55, the lower rotary disc 56, and the sheet 64. Further, in this state, as shown in FIG. 15(a), since the shaft gear 65g connected to the swing shaft 65a is rotated clockwise and the third switching gear 66j is rotated counterclockwise, the fourth switching gear 66k is also rotated counterclockwise as shown in FIG. 13(b). As a result, since the knob 59 is moved downward via the knob shaft part 59c, and a driving engaged part (not shown) provided on the knob 59 is engaged with a driving engagement part (not shown) provided on the upper rotary disc 55, the sheet 64 can be fast forwarded or rewound at a high speed along with the rotation of the knob 59.

The music box device of the present invention is not limited to the embodiments described above, but includes various modifications. For example, in the drawings used in the description of the present embodiment, each component member is shown in a simplified manner, but not limited to this form. Further, in the above-described embodiment, the handle 2c1 to be turned by hand is provided as a driving part to rotate the sheet 14, but the sheet 14 may be rotated by a motor.

### INDUSTRIAL APPLICABILITY

According to the music box device of the present invention, since it is possible to play music for a long time and also suppress the thickness, it is suitable not only for use of the music box device alone but also for use in combination with other articles.

### REFERENCE SIGNS LIST

1 music box device
2 music box body
2a star wheel
2a1 claw
2b vibration valve
2c driving means
2c1 handle
2c2 first gear
2c3 second gear
2c4 third gear
2c5 fourth gear
2c6 shaft
2c7 first support part
2c8 shaft gear
2c9 second support part
2c10 locking gear
2c11 recess
2d spacer
3 upper partition plate
3a hole of upper partition plate
4 lower partition plate
4a hole of lower partition plate
5 upper rotary disc (first rotary disc)
5a radial groove
5b rotary-disc drive gear
5c driving engagement part
6 lower rotary disc (second rotary disc)
7 synchronizing gear (synchronizing mechanism)
8 connecting member
9 knob
9a small-diameter cylindrical portion (shaft movement engagement part)
9b large-diameter cylindrical portion
9c driving engaged part
10 top plate (cover plate)
10a spiral groove
11 pin
12 protective plate
13 bottom plate
14 sheet
14a playing engagement part
15 lock mechanism
15a disc
15b lever
15c lock member
16 shaft depression assisting mechanism
16a second shaft
16b arm
51 music box device
52 music box body
52a star wheel
52c1 handle
52c2 first drive gear
52c3 shaft
52c4 second drive gear
52c5 third drive gear
52d spacer
53 upper partition plate
54 lower partition plate
55 upper rotary disc (first rotary disc)
56 lower rotary disc (second rotary disc)
57 synchronizing gear (synchronizing mechanism)
58 connecting member
59 knob
59a upper knob part
59b lower knob part
59c knob shaft part
60 top plate (cover plate)
61 pin
63 bottom plate
63a cylindrical portion
64 sheet
65 sheet pressing mechanism
65a swing shaft
65b arm
65c drive shaft
65d shaft gear
65e driving roller
65f pressing roller
65g shaft gear
66 mode switching mechanism
66a slide switch
66b first link
66c second link
66d shaft
66e first switching gear
66f second switching gear
66g idler
66h switching shaft
66j third switching gear
66k fourth switching gear
S1 spring
S2 spring
S3 spring

1. A music box device comprising: a sheet that has a playing engagement part and is rotated by a driving means; a star wheel arranged oppositely to the sheet and having two or more claws on an outer peripheral surface; and a vibration valve arranged adjacent to the star wheel, wherein as the sheet is rotated by the driving means, the playing engagement part is linked with one claw to rotate the star wheel, and another claw plucks the vibration valve to play music, wherein
the sheet has a helical plate shape.

2. The music box device according to claim 1, wherein the driving means includes a first rotary disc connected to one end of the sheet, a second rotary disc connected to another end of the sheet, and a synchronizing mechanism to synchronously rotate the first rotary disc and the second rotary disc.

3. The music box device according to claim 2, further comprising:
a cover plate including a spiral groove provided facing at least one of the first rotary disc and the second rotary disc, and a pin movable in the spiral groove, wherein
at least one of the first rotary disc and the second rotary disc facing the cover plate has a radial groove extending in a radial direction and holding the pin movably.

4. The music box device according to claim 2, wherein
the driving means includes a shaft to integrally rotate a spacer that holds the star wheel to be idly rotatable and is provided coaxially with the star wheel, and
the driving means further includes a sheet pressing mechanism having a driving roller that sandwiches the sheet in between with the spacer and is rotated by the driving means to feed out the sheet and a pressing roller that is mounted to a drive shaft to be rotated together with the driving roller and brings the sheet toward the spacer.

5. The music box device according to claim 4, wherein the driving roller is configured to rotate the sheet at a rotational speed consistent with the first rotary disc and the second rotary disc.
